(19) United States
(12) Patent Application Publication
(10) Pub. No.: US 2017/0213637 A1
(43) Pub. Date: Jul. 27, 2017

(54) VERTICALLY STACKED INDUCTORS AND TRANSFORMERS

(71) Applicant: GLOBALFOUNDRIES INC., GRAND CAYMAN (KY)

(72) Inventor: Venkata Narayana Rao Vanukuru, Bangalore (IN)

(21) Appl. No.: 15/003,532

(22) Filed: Jan. 21, 2016

(51) Int. Cl. H01F 27/28; H01F 41/06

(52) U.S. Cl. CPC H01F 27/2823; H01F 41/06

(57) ABSTRACT

The present disclosure relates generally to semiconductor structures, and more particularly, to structures and methods for implementing high performance vertically stacked inductors and transformers. The structure includes: a first conductor composed of a redistribution line; a second conductor composed of a back end of line wiring layer, coupled to the redistribution line; and a ferro magnetic material between the first conductor and the second conductor.

### FIELD OF THE DISCLOSURE

The present disclosure relates generally to semiconductor structures, and more particularly, to structures and methods for implementing high performance vertically stacked inductors and transformers.

### BACKGROUND

An inductor is an important component for an electric circuit with a resistor, a capacitor, a transistor and a power source. The inductor has a coil structure where a conductor is wound many times as a screw or spiral form, as an example. The inductor suppresses a rapid change of a current by inducing voltage in proportion to an amount of a current change. A ratio of counter electromotive force generated due to electromagnetic induction according to the change of the current flowing in a circuit is called an inductance (L).

Generally, the inductor is used in an Integrated Circuit (IC) for communication systems including high performance RF filters, and distributed amplifiers. In particular, inductors are used in a packaging technology for integrating many elements to a single chip, known as a System on Chip (SoC). Accordingly, an inductor having a micro-structure and good electrical characteristics is needed.

A transformer is an electrical device that transfers electrical energy between two or more circuits through electromagnetic induction. Commonly, transformers are used to increase or decrease the voltages of alternating current in electric power applications. For example, in operation, a varying current in the transformer's primary winding creates a varying magnetic flux in the transformer core and a varying magnetic field impinging on the transformer's secondary winding. This varying magnetic field at the secondary winding induces a varying electromotive force (EMF) or voltage in the secondary winding due to electromagnetic induction. However, very high turns ratio transformers are planar with limited coupling with a large area footprint, which increases manufacturing costs. In addition, existing high turns ratio transformers have reduced current handling capability.

### SUMMARY

In an aspect of the disclosure, a structure includes: a first conductor composed of a redistribution line; a second conductor composed of a back end of line wiring layer, coupled to the redistribution line; and a ferro magnetic material between the first conductor and the second conductor.

In an aspect of the disclosure, a structure includes: a vertically stacked primary winding comprising a first conductor composed of a redistribution line and a second conductor composed of a back end of line wiring layer, coupled to the redistribution line; and a vertically stacked secondary winding coupled to the vertically stacked primary winding and comprising the back end of line wiring layer and a lower back end of the line wiring stacked underneath the back end of the line wiring layer.

In an aspect of the disclosure, a method includes: forming a first conductor composed of a redistribution line; forming a second conductor composed of a back end of line wiring layer, coupled to the redistribution line; and forming a ferro magnetic material between the first conductor and the second conductor.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1 is an exploded view of a vertically stacked inductor and transformer in accordance with aspects of the disclosure.

FIG. 2 is a layout view showing a vertically stacked inductor and transformer in accordance with aspects of the disclosure.

FIG. 3 is a cross-section view of an inductor structure in accordance with aspects of the present disclosure.

FIG. 4 is a cross-section view of a vertically stacked inductor and transformer in accordance with aspects of the disclosure.

### DETAILED DESCRIPTION

The present disclosure relates generally to semiconductor structures, and more particularly, to structures and methods for implementing high performance vertically stacked inductors and transformers. More specifically, the present disclosure is directed to a vertically stacked inductor with high inductance density, and a highly efficient vertically stacked transformer with high turns ratio and excellent (e.g., high) current handling. Advantageously, the vertically stacked inductor and transformer disclosed herein are fabricated using a combination of a redistribution layer (RDL) and back end of the line (BEOL) layers.

In embodiments, the vertically stacked inductors and transformers are symmetric three dimensional (3D) structures. Moreover, the vertically stacked transformer has high turns ratio (e.g., impedance transformation ratio) with improved coupling and current handling capability. In more specific embodiments, the vertically stacked transformer has high gain and lower insertion loss, compared to conventional planar transformers. In this way, the vertically stacked transformer can be used to improve the performance of on-chip power amplifiers.

On the other hand, the 3D symmetric inductor structure has high inductance density, high Quality (Q) factor and a high self resonant frequency. In order to accomplish these advantages, the vertically stacked inductor structure can include a magnetic material between the BEOL layer and the RDL.

The vertically stacked inductor and transformer are also compatible with CMOS processes. In embodiments, the vertically stacked inductor and transformer can be composed of multiple spirals of wiring structures (conductors). For example, and without limitations, the following design rules can be utilized:

(i) The total width or the diameter of the spiral turns may be reduced at a constant rate or any other monotonic rate (including periodically constant) as the radius is reduced toward the center of the coil;

(ii) The space between each consecutive spiral turn may be increased at a constant rate or any other monotonic rate (including periodically constant) as the radius is reduced toward the center of the coil;

(iii) The width or diameter of each spiral segment may be reduced at a constant rate or any other monotonic rate (including periodically constant) as the radius is reduced toward the center of the coil;

(iv) The space between segments in upper and adjacent lower spiral turns may be increased at a constant rate or any other monotonic rate (including periodically constant) as the radius is reduced toward the center of the coil;

(v) The width of the upper spiral can be made significantly different from the adjacent lower spiral without disturbing the overall inductor structure;

(vi) The width and spacing of the upper and adjacent lower spirals turns can be different without altering the device structure;

(vii) The upper and adjacent lower spirals can have a slight offset instead of being perfectly aligned vertically to each other;

(viii) The spacing between segments within a turn can be increased while the total turn width can be decreased, maintaining a constant low frequency inductance and resistance, to further enhance high frequency performance; and/or

(ix) More than one vertically adjacent metal layer can be connected in parallel to realize any of the upper or lower spirals to decrease series resistance.

The vertically stacked inductors and transformers of the present disclosure can be manufactured in a number of ways using a number of different tools. In general, though, the methodologies and tools are used to form structures with dimensions in the micrometer and nanometer scale. The methodologies, i.e., technologies, employed to manufacture the symmetric multi-port inductors have been adopted from integrated circuit (IC) technology. For example, the structures of the present disclosure are built on wafers and are realized in films of material patterned by photolithographic processes on the top of a wafer. In particular, the fabrication of the symmetric multi-port inductors uses three basic building blocks: (i) deposition of thin films of material on a substrate, (ii) applying a patterned mask on top of the films by photolithographic imaging, and (iii) etching the films selectively to the mask. In addition, the upper most coil can be composed of a redistribution layer (RDL), which can be formed using different processes such as, for example, soldering, adhesion or bonding of a metal layer, deposition and etching processes, etc.

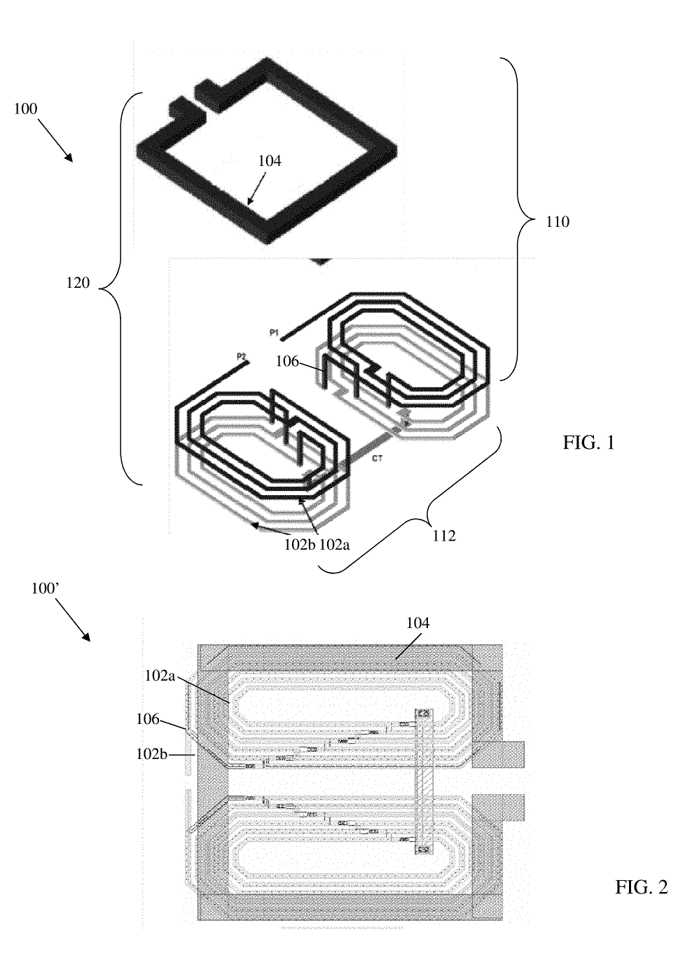

FIG. 1 is an exploded view of a vertically stacked inductor and transformer in accordance with aspects of the disclosure. More specifically, the structure 100 includes a vertically stacked inductor 110 composed of a BEOL layer 102a and an upper redistribution layer 104. The BEOL layer 102a comprises ports P1, P2 which may be used as a contact point for the structure.

As should be understood by those of skill in the art, the RDL 104 is an extra metal layer on a top surface of the structure 100 that makes the IO pads of an integrated circuit available in other locations. As should further be understood by those of skill in the art, the RDL 104 does not have the same processing constraints as the BEOL layer 102a. In fact, the constraints placed on the RDL 104 are known to be significantly less stringent compared to the BEOL layer 102a. For example, the RDL 104 can have a thickness of about 6 μm to 7 μm compared to the thickness of the BEOL layer 102a of about 3 μm to about 5 μm; although other dimensions are contemplated herein depending on the design parameters of the vertically stacked inductor 110. The spacing between the windings of the BEOL layer 102a can be about 2 μm to about 5 μm; although other dimensions are also contemplated by the present disclosure.

In embodiments, the RDL 104 is shown as a single winding, however, one of skill in the art would understand that the RDL 104 can be multiple windings having the same pitch or different pitch than the underlying BEOL layer 102a (as shown in FIGS. 2-4). In embodiments, the RDL 104 can also have different dimensions, e.g., width, height and shape, than the BEOL layer 102a or any combinations thereof. In further embodiments, the design rules (i)-(ix) for the wiring layers (conductors) can be implemented with this and any of the embodiments described herein. For example, the spacing between the windings of the BEOL layer 102b can be about 2 μm to about 5 μm; although other dimensions are also contemplated by the present disclosure.

In embodiments, the RDL 104 can be a metal material, e.g., copper, manufactured in a number of inexpensive ways (compared to the BEOL layer 102a). For example, the RDL 104 can be solder or an adhesion or bonding of a metal layer to the upper surface of the structure 100, e.g., to an upper surface of a dielectric layer. Alternatively, the RDL 104 can be formed using deposition and etching (reactive ion etching (RIE)) processes, but with less stringent design rules compared to the BEOL layer 102a.

Still referring to FIG. 1, the structure 100 further includes a vertically stacked transformer 120. In embodiments, the vertically stacked transformer 120 is composed of the BEOL layer 102a and BEOL layer 102b (as a secondary winding) and RDL 104 (as the primary winding with the BEOL layer 102a), or vice versa. In embodiments, the BEOL layers 102a, 102b are copper or aluminum layers formed using conventional CMOS processes. For example, the BEOL layers 102a, 102b can be formed using conventional additive or subtractive metallization processes, e.g., deposition, lithography and etching processes. The BEOL layers 102b can have the same or different dimensions and spacings as the BEOL layer 102a, depending on the particular design rules as described herein.

In embodiments, the BEOL layers 102a, 102b are vertically stacked and can be connected by one or multiple metal vias 106. Also, the BEOL layers 102a, 102b can be composed of one or more windings in different configurations. For example, the BEOL layers 102a, 102b can be spiral windings formed in any number of different shapes, including octagonal, square, rectangle, circular, hexagonal, etc., with a certain number of turns, e.g., three, five, six, seven, etc. with a certain predefined spacing therebetween as already described herein. In the embodiment shown, the BEOL layers 102a, 102b include three windings. Moreover, the stacked wirings of the BEOL layers 102a, 102b can be two or more separate structures on a same plane, in a symmetrical configuration as shown by reference numeral 112.

FIG. 2 shows a layout view of the vertically stacked inductor and transformer in accordance with aspects of the disclosure. More specifically, the structure 100′ includes the vertically stacked inductor composed of the BEOL layer 102a and the upper RDL 104. As in the previous embodiment, the RDL 104 is shown as a single winding, although any appropriate number of windings for a specific design rule are contemplated. The RDL 104 can have the same pitch or different pitch than the underlying BEOL layer 102a, and can also have different dimensions, e.g., width, height and shape, than the BEOL layer 102a or any combinations thereof. As noted already herein, the design rules (i)-(ix) for the wiring layers (conductors) can be implemented with this and any of the embodiments described herein.

In embodiments, the RDL 104 can have a thickness of about 6 μm to 7 μm compared to the thickness of the BEOL layer 102a of about 3 μm to about 4 μm; although other dimensions are contemplated herein depending on the design parameters of the vertically stacked inductor. Also, as noted already herein, the RDL 104 can be a metal material, e.g., copper, manufactured in a number of inexpensive ways (compared to the BEOL layer 102a), with less stringent design rules compared to the BEOL layer 102a.

Still referring to FIG. 2, the structure 100′ further includes a vertically stacked transformer composed of the BEOL layer 102a and BEOL layer 102b as a secondary winding, and RDL 104 with the BEOL layer 102a as the primary winding. However, depending on the amount of turns and hence inductance, the BEOL layer 102a and BEOL layer 102b can be the primary winding, and RDL 104 with the BEOL layer 102a can be the primary winding.

In embodiments, the BEOL layers 102a, 102b are copper or aluminum layers formed using conventional CMOS processes. In this implementation, the BEOL layers 102a, 102b are vertically stacked and can be connected by one or multiple vias 106, and can have dimensions and spacings as already described herein. Also, the BEOL layers 102a, 102b can be composed of one or more windings in different configurations, e.g., six windings (although other number of windings are also contemplated herein). The BEOL layers 102a, 102b can be spiral windings formed in any number of different shapes, including octagonal, square, rectangle, circular, hexagonal, etc. Moreover, the stacked wirings of the BEOL layers 102a, 102b can be two or more separate structures on a same plane, in a symmetrical configuration, with the RDL layer 104 stacked on top of the BEOL layers 102a, 102b. In this embodiments, Gₘₐₓ=0.78, K=0.68, N=10 and IL=1.06.

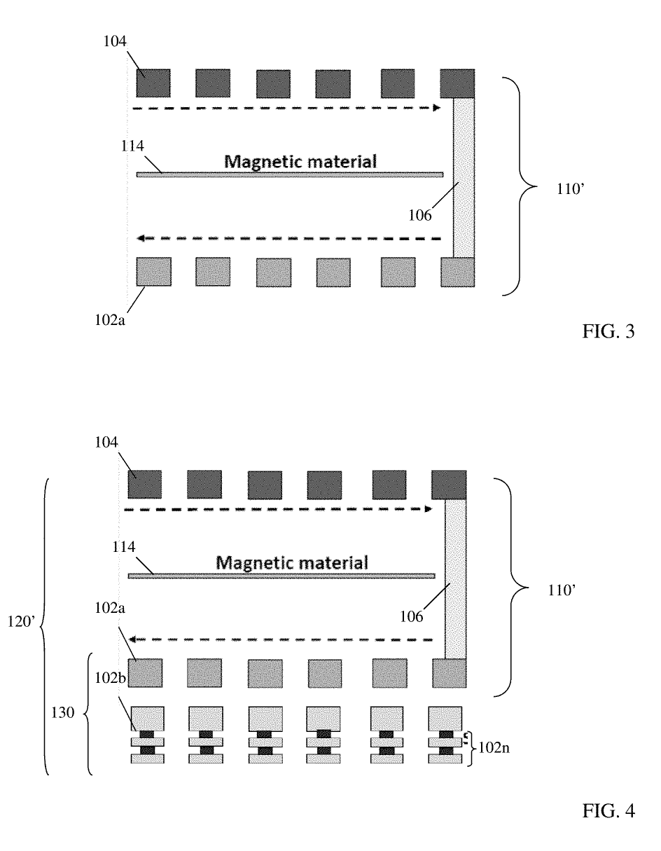

FIG. 3 shows a cross-sectional view of the vertically stacked inductor in accordance with aspects of the disclosure. More specifically, the vertically stacked inductor 100′ includes the BEOL layer 102a and the upper RDL 104, with an intervening magnetic layer 114 (e.g., ferro magnetic material). The magnetic layer 114 can be about 2 μm to about 10 μm in thickness; although other dimensions are also contemplated herein.

In embodiments, the magnetic layer 114 can be an electrically floating plane about 2 to 5 microns above and below respective layers 102a, 104. In further embodiments, the magnetic layer 114 can be a patterned magnetic layer, unlike a solid plane of magnetic material. In embodiments, the patterned magnetic layer 114 can extend beyond an edge of the inductor by 0-20%; although other extended regions are also contemplated by the present disclosure. In embodiments, the magnetic layer 114 can be CoTaZr alloy used with CMOS processes; although other magnetic materials are also contemplated to be used herein. In preferred embodiments, the magnetic layer 114 should retain its properties up to about 400° C., and would have a permeability of about 870 and a ferromagnetic resonance of about 1.4 GHz. Moreover, the magnetic layer 114 should have H_{c} of approximately 0.2 Oe and a resistivity of about 100 μΩ.

Still referring to FIG. 3, the BEOL layer 102a and the RDL 104 include a plurality of windings, e.g., six, although any appropriate number of windings for a specific design rule are contemplated by the present disclosure. The RDL 104 and the BEOL 102a can have the same pitch or different pitch, and can also have the same or different dimensions, e.g., width, height and shape, or any combinations thereof. As noted already herein, the design rules (i)-(ix) for the wiring layers (conductors) can be implemented with this and any of the embodiments described herein.

By way of illustrative example, the RDL 104 can have a thickness of about 6 μm to 7 μm compared to the thickness of the BEOL layer 102a of about 3 μm to about 4 μm; although other dimensions are contemplated herein depending on the design parameters of the vertically stacked inductor 110′. Also, as noted already herein, the RDL 104 can be a metal material, e.g., copper, manufactured in a number of inexpensive ways (compared to the BEOL layer 102a) as already noted herein, with less stringent design rules compared to the BEOL layer 102a.

On the other hand, the BEOL layer 102a is formed by CMOS processes. For example, as in each of the embodiments, a dielectric layer 116 can be deposited and patterned using conventional processes. For example, the dielectric layer 116 can be deposited using a conventional chemical vapor deposition (CVD) process. A resist is formed on the dielectric layer 116 and exposed to energy (light) to form a pattern (openings). An etching process, e.g., reactive ion etching (RIE) with appropriate chemistries, can then be performed to form shallow trenches in the dielectric layer 116 in the pattern of the windings. The resist can be removed using conventional stripants, e.g., oxygen ashing. A metal material, e.g., tungsten, copper or aluminum, etc., can be deposited within the openings to form the BEOL layer 102a. Any residual metal can be removed by a chemical mechanical polish (CMP). The metal layer 114 can be formed in a similar manner, such that no further explanation is required for one of ordinary skill in the art to understand the present disclosure.

FIG. 4 is a cross-section view of a vertically stacked inductor and transformer in accordance with aspects of the disclosure. In this embodiment, the vertically stacked transformer includes the inductor structure 110′ of FIG. 3, e.g., coupled stacked serial inductor as the primary winding of the transformer. In addition, the transformer 120′ includes the BEOL layer 102a, in addition to BEOL layers 102b, 102n. In embodiments, the BEOL layer 102n can be a plurality of layers, e.g., two or more layers connected by a via structure, having a thickness of about 0.4 μm to about 0.6 μm; whereas, the BEOL layers 102a, 102b can have a thickness of about 3.0 μm to about 4.0 μm. In embodiments, the secondary winding of the transformer 120′ can include the BEOL layers 102b, 102n. The BEOL layers 102a, 102b can be formed using conventional CMOS processes as already described herein.

The method(s) as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A structure, comprising:
a first conductor composed of a redistribution line;
a second conductor composed of a back end of line wiring layer, coupled to the redistribution line; and
a ferro magnetic material between the first conductor and the second conductor.

2. The structure of claim 1, wherein the first conductor and the second conductor are wound in a spiral configuration.

3. The structure of claim 2, wherein the first conductor is a single winding.

4. The structure of claim 2, wherein the first conductor and the second conductor are multiple windings.

5. The structure of claim 1, wherein the first conductor, the second conductor and the ferro magnetic material form an inductor.

6. The structure of claim 5, wherein the inductor is a symmetric inductor.

7. The structure of claim 1, further comprising a back end of the line stacked configuration which forms a secondary wiring of a transformer, and a primary wiring formed from the first conductor composed of the redistribution line and the second conductor.

8. The structure of claim 7, wherein the back end of the line wiring layer of the second conductor forms an upper part of the back end of the line stacked configuration which forms the secondary wiring.

9. The structure of claim 7, wherein the back end of the line stacked configuration is a vertically stacked configuration of multiple windings.

10. The structure of claim 9, wherein the multiple windings is a spiral configuration.

11. The structure of claim 1, wherein the ferro magnetic layer is about 2 μm to about 10 μm in thickness.

12. The structure of claim 1, wherein the ferro magnetic layer is CoTaZr alloy.

13. A structure, comprising:
a vertically stacked primary winding comprising a first conductor composed of a redistribution line and a second conductor composed of a back end of line wiring layer, coupled to the redistribution line; and
a vertically stacked secondary winding coupled to the vertically stacked primary winding and comprising the back end of line wiring layer and a lower back end of the line wiring stacked underneath the back end of the line wiring layer.

14. The structure of claim 13, further comprising a ferro magnetic material between the first conductor and the second conductor.

15. The structure of claim 14, wherein the ferro magnetic material is CoTaZr alloy.

16. The structure of claim 13, wherein the redistribution line is a single winding and the back end of line wiring layer and the lower back end of the line wiring stacked underneath the back end of the line wiring layer are multiple windings.

17. The structure of claim 13, wherein:
the redistribution line is multiple windings and the back end of line wiring layer and the lower back end of the line wiring stacked underneath the back end of the line wiring layer are multiple windings; and
the redistribution line, the back end of line wiring layer and the lower back end of the line wiring have a same amount of windings, with same spacing.

18. The structure of claim 13, wherein the redistribution line has different design constraints than the back end of line wiring layer and the lower back end of the line wiring.

19. A method comprising:
forming a first conductor composed of a redistribution line;
forming a second conductor composed of a back end of line wiring layer, coupled to the redistribution line; and
forming a ferro magnetic material between the first conductor and the second conductor.

20. The method of claim 19, further comprising forming a lower back end of the line wiring stacked underneath the back end of the line wiring layer.
